(19) United States
(12) Patent Application Publication
(10) Pub. No.: US 2002/0176001 A1
(43) Pub. Date: Nov. 28, 2002

(54) Object tracking based on color distribution

(76) Inventor: Miroslav Trajkovic, Ossining, NY (US)

Correspondence Address: Corporate Patent Counsel, U.S. Philips Corporation, 580 White Plains Road, Tarrytown, NY, 10591, US

(21) Appl. No.: 09/854,044

(22) Filed: May 11, 2001

(51) Int. Cl. H04N 5/225

(52) U.S. Cl. 348/169

(57) ABSTRACT

A color modeling and color matching process and system is provided that uses the hue and saturation of color pixels, in conjunction with the intensity of gray or near-gray pixels, to characterize targets and images. A target is characterized by a histogram of hues and saturation within the target image, with a greater distinction being provided to the hues. Recognizing that the hue of gray, or near-gray, picture elements is highly sensitive to noise, the gray or near-gray pixels are encoded as a histogram of intensity, rather than hue or saturation. The target tracking system searches for the occurrence of a similar set of coincident color-hue-saturation and gray-intensity histograms within each of the image frames of a series of image frames.

### BACKGROUND OF THE INVENTION

1. Field of the Invention

This invention relates to the field of image processing, and in particular to the tracking of target objects in images based on the distribution of color, and particularly the hue and saturation of color pixels and the intensity of gray pixels.

2. Description of Related Art

Motion-based tracking is commonly used to track particular objects within a series of image frames. For example, security systems can be configured to process images from one or more cameras, to autonomously detect potential intruders into secured areas, and to provide appropriate alarm notifications based on the intruder's path of movement. Similarly, videoconferencing systems can be configured to automatically track a selected speaker, or a home automation system can be configured to track occupants and to correspondingly control lights and appliances in dependence upon each occupant's location.

A variety of motion-based tracking techniques are available, based on the recognition of the same object in a series of images from a camera. Characteristics such as object size, shape, color, etc. can be used to distinguish objects of potential interest, and pattern matching techniques can be applied to track the motion of the same object from frame to frame in the series of images from the camera. In the field of image tracking, a ‘target’ is modeled by a set of image characteristics, and each image frame, or subset of the image frame, is searched for a similar set of characteristics.

Precise and robust target modeling, however, generally requires high-resolution, and the comparison process can be computationally complex. This computational complexity often limits target tracking to very high-speed computers, or to off-line (i.e. non-real-time) processing. In like manner, the high-resolution characterization generally requires substantial memory resources for containing the detailed data of each target and each image frame.

### BRIEF SUMMARY OF THE INVENTION

It is an object of this invention to provide a target tracking system and method that is computationally efficient while also being relatively accurate. It is a further object of this invention to provide a target modeling system and method that uses a relatively small amount of memory and/or processing resources.

These objects and others are achieved by providing a color modeling and color matching process and system that uses the hue and saturation of color pixels, in conjunction with the intensity of gray or near-gray pixels, to characterize targets and images. A target is characterized by a histogram of hues and saturation within the target image, with a greater distinction being provided to the hues. Recognizing that the hue of gray, or near-gray, picture elements (pixels) is highly sensitive to noise, the gray or near-gray pixels are encoded as a histogram of intensity, rather than hue or saturation. The target tracking system searches for the occurrence of a similar set of coincident color-hue-saturation and gray-intensity histograms within each of the image frames of a series of image frames. To further simplify the computation and storage tasks, targets are defined in terms of a rectangular segment of an image frame. Recursive techniques are employed to reduce the computation complexity of the color-matching task.

### BRIEF DESCRIPTION OF THE DRAWINGS

The invention is explained in further detail, and by way of example, with reference to the accompanying drawings wherein:

FIG. 1 illustrates an example flow diagram of an image tracking system in accordance with this invention.

FIG. 2 illustrates an example block diagram of an image tracking system in accordance with this invention.

FIG. 3 illustrates an example flow diagram for creating a composite histogram of color hue and saturation, and gray intensity characteristics in accordance with this invention.

Throughout the drawings, the same reference numerals indicate similar or corresponding features or functions.

### DETAILED DESCRIPTION OF THE INVENTION

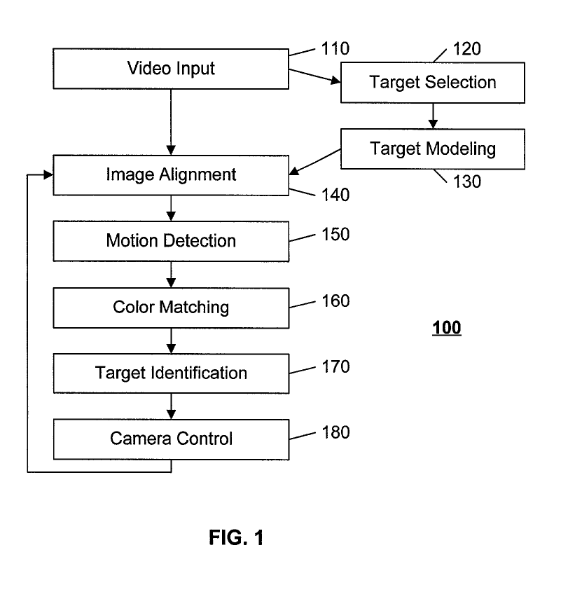

FIG. 1 illustrates an example flow diagram of an image tracking system 100 in accordance with this invention. Video input, in the form of image frames is continually received, at 110, and continually processed, via the image processing loop 140-180. At some point, either automatically or based on manual input, a target is selected for tracking within the image frames, at 120. After the target is identified, it is modeled for efficient processing, at 130. At block 140, the current image is aligned to a prior image, taking into account any camera adjustments that may have been made, at block 180. After aligning the prior and past images in the image frames, the motion of objects within the frame is determined, at 150. Generally, a target that is being tracked is a moving target, and the identification of independently moving objects improves the efficiency of locating the target, by ignoring background detail. At 160, color matching is used to identify the portion of the image, or the portion of the moving objects in the image, corresponding to the target. Based on the color matching and/or other criteria, such as size, shape, speed of movement, etc., the target is identified in the image, at 170.

In an integrated security system, the tracking of a target generally includes controlling one or more cameras to facilitate the tracking, at 180. In a multi-camera system, the target tracking system 100 determines when to “hand-off” the tracking from one camera to another, for example, when the target travels from one camera's field of view to another. In either a single or multi-camera system, the target tracking system 100 may also be configured to adjust the camera's field of view, via control of the camera's pan, tilt, and zoom controls, if any. Alternatively, or additionally, the target tracking system 100 may be configured to notify a security person of the movements of the target, for a manual control of the camera, or selection of cameras.

As would be evident to one of ordinary skill in the art, a particular tracking system may contain fewer or more functional blocks than those illustrated in the example system 100 of FIG. 1. Not illustrated, the target tracking system 100 may be configured to effect other operations as well. For example, in a security application, the tracking system 100 may be configured to activate audible alarms if the target enters a secured zone, or to send an alert to a remote security force, and so on. In a home-automation application, the tracking system 100 may be configured to turn appliances and lights on or off in dependence upon an occupant's path of motion, and so on.

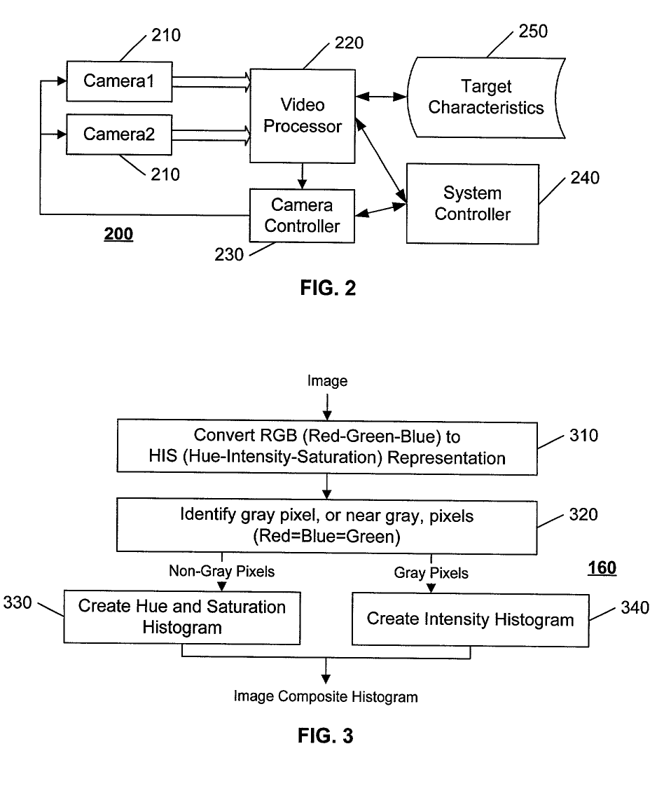

The tracking system is preferably embodied as a combination of hardware devices and one or more programmed processors. FIG. 2 illustrates an example block diagram of an image tracking system 200 in accordance with this invention. One or more cameras 210 provide input to a video processor 220. The video processor 220 processes the images from one or more cameras 210, and stores target characteristics in a memory 250, under the control of a system controller 240. In a preferred embodiment, the system controller 240 also facilitates control of the fields of view of the cameras 210, and select functions of the video processor 220. As noted above, the tracking system 200 may control the cameras 210 automatically, based on tracking information that is provided by the video processor 220.

This invention primarily addresses the color matching task 160, and the corresponding target modeling task 130, and target identification task 170 used to effect the color matching process of this invention. The color matching process is based on the observation that some visual characteristics are more or less sensitive to environmental changes, such as lighting, shadows, reflections, and so on. For ease of reference, uncontrolled changes in conditions that affect visual characteristics is herein termed ‘noise’.

It has been found that the noise experienced in a typical environment generally relates to changes in the brightness of objects, as the environmental conditions change, or as an object travels from one set of environmental conditions to another. In a preferred embodiment of this invention, a representation that provides a separation of brightness from chromacity is used, to provide a representation that is robust to changes in brightness while still retaining color information. Experiments have shown that the HSI (Hue, Saturation, Intensity) color model provides a better separation between brightness and chromacity than the RGB (Red, Green, Blue) color model that is typically used in video imaging. Hue represents dominant color as perceived by an observer; saturation represents the relative purity, or the amount of white mixed with the color; and intensity is a subjective measure that refers to the amount of light provided by the color. Other models, such as YUV, or a model specifically created to distinguish brightness and chromacity, may also be used.

FIG. 3 illustrates an example flow diagram for creating a composite histogram of color hue and saturation, and gray intensity characteristics in accordance with this invention, as may be used in block 160, and corresponding block 130, in FIG. 1. It is assumed herein that the input image comprises RGB color components, although the source may provide YUV components, or others, and it is assumed that an HSI color model is being used for characterizing the image. The RGB image is converted to an HSI image, at 310. The equations for effecting this conversion are provided below; equations for converting to and from other color model formats are generally known to those skilled in the art.

I=⅓(R+G+B)

$$\begin{matrix}S = 1 - \frac{min ( R , G , B )}{I} \\ H = {cos}^{- 1} \{ \frac{3}{2} \frac{R - I}{\sqrt{{( R - G )}^{2} + ( R - B ) ( G - B )}} \}\end{matrix}$$

The intensity component, I, can be seen to correspond to an average magnitude of the color components, and is substantially insensitive to changes in color and highly sensitive to changes in brightness. The hue component, H, can be seen to correspond to relative differences between the red, green, and blue components, and thus is sensitive to changes in color, and fairly insensitive to changes in brightness. The saturation component, S, is based on a ratio of the minimum color component to the average magnitude of the color components, and thus is also fairly insensitive to changes in brightness, but, being based on the minimum color component, is also somewhat less sensitive to changes in color than the hue component.

Note, however, that the hue component, being based on a relative difference between color components, is undefined (nominally 0) for the color gray, which is produced when the red, green, and blue components are equal to each other. The hue component is also highly variable for colors close to gray. For example, a ‘near’ gray having an RGB value of (101, 100, 100) has a HSI value of (0, 0.0033, 100.333) whereas an RGB value of (100, 101, 100) produces a HSI value of (2.09, 0.0033, 100.333), even though these two RGB values are virtually indistinguishable (as evidenced by the constant values of saturation and intensity). Similar anomalies in hue and saturation components occur for low-intensity color measurements as well.

Experiments have confirmed that both the hue and saturation components are effective for distinguishing color, and that the hue component is more robust than the saturation component for distinguishing true color, but highly sensitive to noise for gray or near gray colors, or colors with an overall low intensity level. For ease of reference, colors with very low intensity levels are herein defined as non-colors, because the color of a very low intensity pixel is substantially indistinguishable from black (or dark gray), and/or because determining the true color components of a low intensity input signal to a camera has a high noise factor.

In accordance with this invention, separate histograms are used to characterize color (i.e. non-gray) pixels from non-color (i.e.gray, or near-gray, or low-intensity) pixels. A composite of these two histograms is used for target characterization and subsequent color matching within an image to track the motion of the characterized target. As illustrated in FIG. 3, at 320, gray, or near-gray, pixels (R˜G˜B) are identified, preferably by defining all colors that lie within a toroid of the R=G=B line in the RGB color space to be near-gray. The radius of the toroid defines the boundary for defining each pixel as either non-gray (color) or gray (non-color), and is preferably determined heuristically. Generally a radius of less than ten percent of the maximum range of the color values is sufficient to filter gray pixels from color pixels.

A histogram is created for each color pixel, at 330, for recording the occurrence of each hue-saturation pair. Because hue has been found to be a more sensitive discriminator of color, the resolution of the histogram along the hue axis is finer than the resolution along the saturation axis. In a preferred embodiment, the hue axis is divided into 32 hue values and the saturation axis is divided into 4 saturation values, for a total of 128 histogram ‘bins’ for containing the distribution of hue-saturation pairs contained within the target. At 340, a histogram of intensity levels of the gray pixels is created, nominally as few as 16 different levels of intensity are sufficient to distinguish among gray objects, in combination with the color histogram information. These two histograms form a composite histogram that is used to characterize the target. The composite histogram contains a total number of ‘bins’ that is equal to the sum of the number of different hue-saturation pairs and intensity levels.

By maintaining a histogram of color information after filtering out gray pixels, in accordance with this invention, efficient and effective color discrimination can be achieved, without the variance typically associated with color discrimination among gray, or near-gray, pixels or objects. By maintaining a histogram of intensity information for gray pixels only, efficient and effective discrimination can be achieved, without the variance typically associated the intensity measure of color pixels under different lighting conditions.

In a preferred embodiment, the composite histogram of the target is compared to similarly determined histograms corresponding to regions of the image of substantially the same size and shape as the target. Preferably, to simplify the comparison process, targets are identified as rectangular objects, or similarly easy to define region shapes. Any of a variety of histogram comparison techniques can be used to determine the region in the image that most closely correspond to the target, corresponding to block 170 in FIG. 1. The selected histogram comparison technique determines the characteristics of the target that are stored in the target characteristics memory 250 of FIG. 2 by the target modeling block 130 of FIG. 1. In a preferred embodiment of this invention, the composite histogram, containing both color (hue-saturation) and non-color (intensity) frequency counts is used, although the color and non-color histograms may be processed independently to determine a corresponding region in each image that is processed. If the histograms are processed independently, different histogram comparison techniques may be applied to the color histogram and the non-color histogram.

In a preferred embodiment of this invention, a fast histogram technique as described in copending application “PALETTE-BASED HISTOGRAM MATCHING”, U.S. patent application Ser. No. ______ , filed ______ for Miroslav Trajkovic, Attorney Docket US010239, and incorporated by reference herein, is used for finding a similar distribution of target color and non-color pixels in an image. A histogram vector, containing the N most popular values in the target (of either hue-saturation or intensity) is used to characterize the target, in lieu of the entirety of possible color and non-color values forming the histogram. The target-modeling block 130 of FIG. 1 stores this N-element vector, and an identification of the color or intensity corresponding to each element of the vector, as the target characteristics, in memory 250 of FIG. 2. That is, using the example parameters presented above, the target histogram has a total of 128 possible hue-saturation pairs (32 hue levels×4 saturation levels). Assume in this example that eight intensity levels are used to characterize the non-color pixels, thereby providing a total of 136 possible histogram classes, or ‘bins’, for counting the number of occurrences of chromatic (hue-saturation) values or gray scale (intensity) levels in the target. For ease of reference, the term composite value is used hereinafter to refer to either a hue-saturation pair or an intensity level, depending upon whether the pixel is classified as color or non-color. In a preferred embodiment, the sixteen most frequently occurring composite values in the target form a 16-element vector. An identification of each of these composite values, and the number of occurrences of each composite value in the target, is stored as the target characteristics in memory 250. The set of composite values forming the target histogram vector is termed the target palette, each of the N most frequently occurring composite values being termed a palette value.

To effect the color comparison in block 170 of FIG. 1, the image is processed to identify the occurrences of the target palette values in the image. All other composite values are ignored. A palette image is formed that contains the identification of the corresponding target palette value for each pixel in the image. Pixels that contain composite values that are not contained in the target palette are assigned a zero, or null, value. A count of each of the non-zero entries in a target-sized region of the image forms the histogram vector corresponding to the region. Thus, by ignoring all image pixel values that are not contained in the target palette, the time required to create a histogram vector for each target-sized region in the image is substantially reduced. The referenced co-pending application also discloses a recursive technique for further improving the speed of the histogram creation process. The similarity measure of each region to the target is determined as:

$$S = {\sum }_{k = 1}^{n} min ( {hR}_{k} , {hT}_{k} ) ,$$

where hR is the histogram vector of the region, hT is the histogram vector of the target, and n is the length, or number of dimension, in each histogram vector. The region with the highest similarity measure, above some minimum normalized threshold, is defined as the region that contains the target, based on the above described color and non-color matching.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A video processing system for characterizing an image, comprising:
a characterizing device that is configured to partition pixels of the image into a first set of color pixels and a second set of non-color pixels, and to create at least one of:
a histogram of chromatic components within the first set of color pixels, and
a histogram of brightness components within the second set of non-color pixels.

2. The video processing system of claim 1, wherein
the characterizing device is further configured to create a composite histogram that includes the histogram of chromatic components and the histogram of brightness components.

3. The video processing system of claim 2, wherein
the composite histogram corresponds to a target histogram, and
the video processing system further includes
a color-matching device that is configured to compare one or more other composite histograms to the target histogram.

4. The video processing system of claim 3, wherein
a limited number of different chromatic component values and brightness component values are used to create a target histogram vector corresponding to the target histogram, and
the color-matching device is configured to create one or more other histogram vectors corresponding to the other composite histograms based on the limited number of different chromatic component values and brightness component values corresponding to the target histogram.

5. The video processing system of claim 1, wherein at least one of:
the chromatic components include at least one of a hue and a saturation component of a hue-saturation-intensity color model, and
the brightness components include an intensity component of the hue-saturation-intensity color model.

6. The video processing system of claim 1, wherein
the histogram of chromatic components corresponds to a target histogram, and
the video processing system further includes
a color-matching device that is configured to compare one or more other histograms of chromatic components to the target histogram.

7. The video processing system of claim 6, wherein
a limited number of different chromatic component values are used to create a target histogram vector corresponding to the target histogram, and
the color-matching device is configured to create one or more other histogram vectors corresponding to the other histograms based on the limited number of different chromatic component values.

8. The video processing system of claim 1, wherein
the second set of non-color pixels are defined based as pixels having color values that lie within a specified distance from a line of gray values in a defined color space.

9. The video processing system of claim 1, further including
a color modeler that is configured to convert a red-green-blue representation of each pixel value into a hue-saturation-intensity representation of the pixel value.

10. The video processing system of claim 1, further including
a target tracker that is configured to track a target in one or more images, based on the histogram of chromatic components.

11. A method of characterizing an image comprising:
partitioning pixels comprising the image into a first set of color pixels and a second set of non-color pixels, and
creating at least one of:
a histogram of chromatic components comprising the first set of color pixels, and
a histogram of brightness components within the second set of non-color pixels.

12. The method of claim 11, further including
creating a composite histogram based on the histograms of chromatic components and brightness components.

13. The method of claim 12, wherein
the composite histogram corresponds to a target histogram, and
the method further includes
comparing one or more other composite histograms to the target histogram.

14. The method of claim 13, wherein
a limited number of different chromatic component values and brightness component values are used to create a target histogram vector corresponding to the target histogram, and
comparing the one or more other composite histograms includes
creating one or more other histogram vectors corresponding to the other histograms based on the limited number of different chromatic component values and brightness component values of the target histogram vector.

15. The method of claim 11, wherein at least one of:
the chromatic components correspond to at least one of a hue component and a saturation component of a hue-saturation-intensity color model of each color pixel, and
the brightness components include an intensity component of the hue-saturation-intensity color model.

16. The method of claim 11, wherein
the histogram of chromatic components correspond to a target histogram, and
the method further includes
comparing one or more other histograms of chromatic components to the target histogram.

17. The method of claim 16, wherein
a limited number of different chromatic component values are used to create a target histogram vector corresponding to the target histogram, and
comparing the one or more other histograms includes
creating one or more other histogram vectors corresponding to the other histograms based on the limited number of different chromatic component values.

18. The method of claim 11, wherein
the second set of non-color pixels are defined based as pixels having color values that lie within a specified distance from a line of gray values in a defined color space.

19. The method of claim 11, further including
converting a red-green-blue representation of each pixel value into a hue-saturation-intensity representation of the pixel value.
